(19) United States
(12) Patent Application Publication
(10) Pub. No.: US 2017/0054245 A1
(43) Pub. Date: Feb. 23, 2017

(54) Luggage or Bag for Convenient Replacement of Charging Cable

(71) Applicant: Li Zhijian, Fujian (CN)

(72) Inventor: Li Zhijian, Fujian (CN)

(21) Appl. No.: 14/930,719

(22) Filed: Nov. 3, 2015

(30) Foreign Application Priority Data
Aug. 20, 2015 (CN) 201520737260.7

(51) Int. Cl. H01R 13/52; A45F 3/04; H01R 13/72; A45C 15/00; H01R 24/20; H01R 24/28

(52) U.S. Cl. CPC H01R 13/52; H01R 24/20; H01R 24/28; H01R 13/72; A45C 15/00; A45F 3/04

(57) ABSTRACT

A luggage or bag for convenient replacement of charging cable, comprising the luggage or bag body, cable laying channel and power cable provided in the cable laying channel, power cable consisting of male connector and female connector, wherein, the said cable laying channel has first port placed at the outer panel of the luggage or bag body, and second port placed at the inside of the luggage or bag body; the said male connector of power cable is exposed outside second port of the cable laying channel, and the said female connector of power cable is exposed outside first port of the cable laying channel; a channel closing or opening accessories is provided at the side of first port of the cable laying channel; the said luggage or bag body is provided with power storage space.

### TECHNICAL FIELD

The present invention relates to a luggage or bag, especially a bag or luggage for convenient replacement of charging cable.

### BACKGROUND OF THE INVENTION

Bags and luggage have become necessity in our everyday lives, such as backpacks (student backpacks and outdoor backpacks), travel luggage, briefcases, lady handbags, shoulder bags and so on. With the constant development of our society, diverse portable digital devices are emerging in our lives, and we rely more and more on them, including tablet computers, cellphones, digital cameras, video cameras and the like. In addition to containing the stuff, the people wants more functions from the bags and luggage, for example, charging the portable digital devices. Especially for tourists, field staff and the people who making long-term business trips, it is not easy to charge their digital devices when the battery is dying, causing a lot of inconvenience and trouble in their works and lives. The present bags and luggage are equipped with no charging function, or a portable power source is provided in a bag or luggage for charging; however, it is necessary to open the bag or luggage for charging, which is quite inconvenient.

The bags and luggage with charging function have been sold on present market; however, the power cable of such bags and luggage are fixed and installed in the bags and luggage with charging functions. Due to long-term service, both terminals of the power cable shall be worn down thus influence the normal application of the said power cable. Moreover, the cord shall be damaged for aging. The bags and luggage with fixed power cable inside bring inconvenience for replacing the power cable, and consequently shall cause inconvenience and trouble for users' daily life. The utility model has the following advantages: the power cable in the cable laying channel can easily be replaced; The power heat generated by charging will not cause any harm to human body; in case of combustion due to charging, a certain reaction time is guaranteed for the user.

### SUMMARY OF THE INVENTION

The utility model intends to overcome the disadvantages stated above, and provides a type of bag or luggage for convenient replacement of charging cable, which enables the user to replace the damaged power cable with a new one when the power cable is damaged due to abrasion or aging. In addition, the charging interface is featured with waterproof and dust-proof functions, resulting in reliable performance.

The utility model is realized in the following way: a type of bag or luggage for convenient replacement of power cable, comprising the bag or luggage body, power cable routing channel and power cable through the channel; the power cable is provide with male and female contacts, which features: the said routing channel of power cable is provided with first port set outer surface of the bag or luggage body and second port set inside the bag or luggage body. The said male contact of the power cable is exposed outside the second port of routing channel and the said female contact is exposed outside the first port of routing channel. Closing or opening accessories have been provided at the port side of the said power cable routing channel to close or open the channel. The said bag or luggage body is provided with a place for storing power source. Open the zipper, the channel on the side of the port shall be in open state, which is convenient for replacing the power cable in the power cable routing channel. The said of closing or opening accessories can be zipper (4), buckle/button or vecro/magic tape (9), elastic band (10) or ribbon/webbing or any other accessories which can make the closing and opening. The said buckle or button can be snap button, fastener, magnet button etc.

Further, the said first port at the power cable routing channel is arranged on the shoulder straps of the bag or luggage body and the said second port is arranged away from the surface of junction between the shoulder straps and the bag or luggage body and above the space for storing power source. The said routing channel shall start from the first port and extend along the shoulder straps to the junction between shoulder straps and the bag or luggage body, and then make its way along the side of the bag or luggage body to the bottom of the bag or luggage body. Then the channel shall extend its way along the bottom of bag or luggage body to the space for storing power source away from the surface of junction between the shoulder straps and the bag or luggage body, and finally extend to the second port above the along the space for storing power source. For the surface of the junction between the shoulder straps and the bag or luggage body has a direct contact with human body of the user, it is designed to arrange the space for storing power source away from the contact part of human body. In this way, no personal injury shall be made in case of heating of power source during the charging process. Moreover, in case of burning accident resulted from charging, it is possible for the user to win certain reaction time.

Further, the said first port at the power cable routing channel is arranged on the shoulder strips of the bag or luggage body, and the said second port at the power cable routing channel is set inside the surface at the junction between the shoulder strips and the bag or luggage body.

Further, the said first port at the power cable routing channel shall be set at any position of the bag or luggage body, such as on the side of the bag or luggage body. Further, the said first port at the power cable routing channel is set at the groove at any side of the bag or luggage body, and the said second port at the power cable routing channel is set on the interlining inside the bag or luggage body. The said routing channel starts from the first port, runs through the said groove and extends its way into the interlining of the bag or luggage body, and finally reaches the second port along the interlining.

Further, the said female connector is provided with a sheath for water proofing wrapped on the outer surface of the female connector, wherein said sheath is further equipped with a dust cap for dust proofing.

Compared with the available technology, the utility model enjoys the following advantages: (1) The present invention provides a bag or luggage for convenient replacement of charging cable in the power routing channel. (2) The present invention provides a bag or luggage for convenient replacement of charging cable. For the surface of the junction between the shoulder straps and the bag or luggage body has a direct contact with human body of the user, it is designed to arrange the space for storing power source away from the contact part of human body. In this way, no personal injury shall be made in case of heating of power source during the charging process. Moreover, in case of burning accident resulted from charging, it is possible for the user to win certain reaction time. (3) The present invention provides a bag or luggage for convenient charging, which enables a user to charge a product needing to be charged conveniently at any time or any place during traveling, without necessarily opening the bag or luggage, nor taking out the power source for charging. In addition, the charging interface is featured with waterproof and dust-proof functions, resulting in reliable performance.

### BRIEF DESCRIPTION OF THE DRAWINGS

The utility model is further described as follows with reference to drawings and embodiments:

FIG. 1 is a structural schematic diagram of embodiment 1 of the utility model (a backpack with long power cable and with a zipper on shoulder strap);

FIG. 2 is a structural schematic diagram of the power cable of embodiment 2 of the utility model (a backpack with velcro on shoulder strap);

FIG. 3 is a structural schematic diagram of embodiment 3 of the utility model (a backpack with short power cable and elastic on shoulder strap);

FIG. 4 is a structural schematic diagram of embodiment 4 of the utility model;

FIG. 5 is a structural schematic diagram of embodiment 5 of the utility model;

FIG. 6 is a structural schematic diagram of embodiment 6 of the utility model (handbag);

FIG. 7 is a structural schematic diagram of embodiment 7 of the utility model (luggage);

FIG. 8 is a structural schematic diagram of embodiment 8 of the utility model (purse).

FIGS. 9 and 10 are side views of the utility model according to the present invention.

FIG. 11 is a rear view of luggage according to the present invention.

Description of the symbols in the drawings: 1. bag or luggage body; 2. power cable; 2.1. male connector; 2.2. female connector; 2.3. water proofing sheath; 2.4. dust cap; 3. cable laying channel; 3.1. first port; 3.2. second port; 4. fastening connecting or opening the channel; 5. Groove; 6. electrical storage device placing space; 7. shoulder strap; 8. Interlayer; 9. magic tape; 10. elastic; 11. ribbon.

### DETAILED DESCRIPTION OF THE EMBODIMENTS

The content of the utility model is further described in detail as follows with reference to the drawings for specification and specific embodiments.

The content of the utility model is further described in detail as follows with reference to the drawings for specification and specific embodiments:

### Embodiment 1

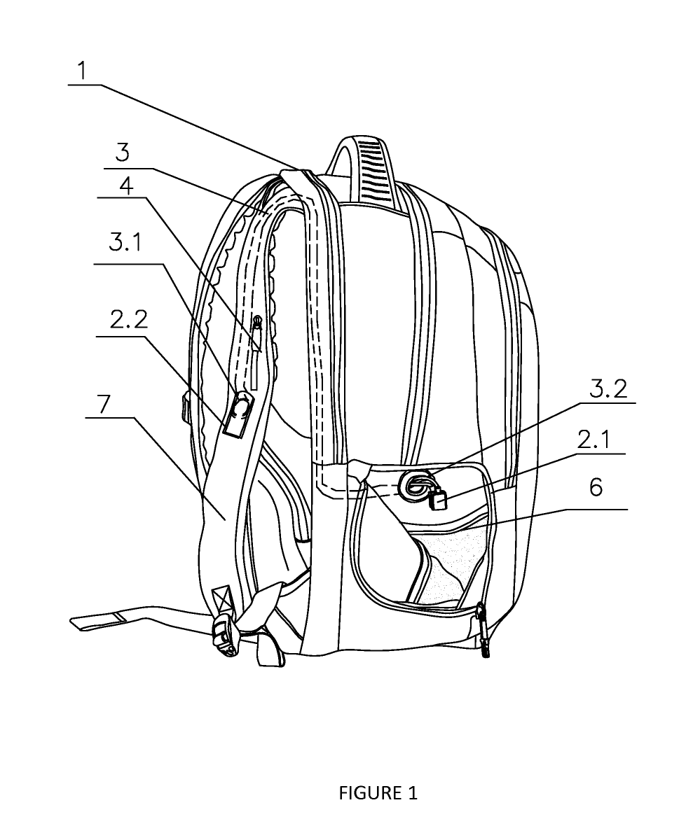

FIG. 1 shows embodiment 1 of the utility model, namely, a backpack, which is a bag or luggage for convenient charging, comprising the bag or luggage body (1), cable laying channel (3) and power cable (2). Male connector (2.1) and female connector (2.2) are equipped on power cable and the feature is: the said cable laying channel (3) has first port (3.1) on the outer surface of said bag or luggage body (1) and second port (3.2) is inside the said bag or luggage body (1) and the male connector (2.1) is on the outer surface of first port (3.1) of the power cable (2) and the female connector (2.2) of said power cable (2) is outside second port (3.2) on the bag or luggage body (1). A zipper is available off the side of first port (3.1) on the bag or luggage body (1), which is used to connect or separate the channel. Electrical storage device placing space (6) is inside the bag or luggage body (1).

The said first port (3.1) of the cable laying channel (3) is on a shoulder strap (7) of the bag or luggage body (1). The said second port (3.2) of the cable laying channel (3) is above electrical storage device placing space (6) away from the joint of shoulder strap or bag or luggage body (1). The cable laying channel starts from first port (3.1) and stretches from shoulder strap (7) to the joint of shoulder strap (7) and the bag or luggage body (1). Then, along the side of the bag or luggage body (1), it extends toward the bottom of the bag or luggage body (1). It then stretches toward electrical storage device placing space (6) on the joint of shoulder strap (7) and the bag or luggage body (1). It, in the end, extends toward second port (3.2) along electrical storage device placing space (6). Considering the shoulder strap and the bag or luggage body has direct contact with human body, the advantage of this embodiment is that electrical storage device placing space is set far from human body; therefore, power supply heating caused by charging will not result in injuries and when a charging combustion accident happens, a user still has time to react.

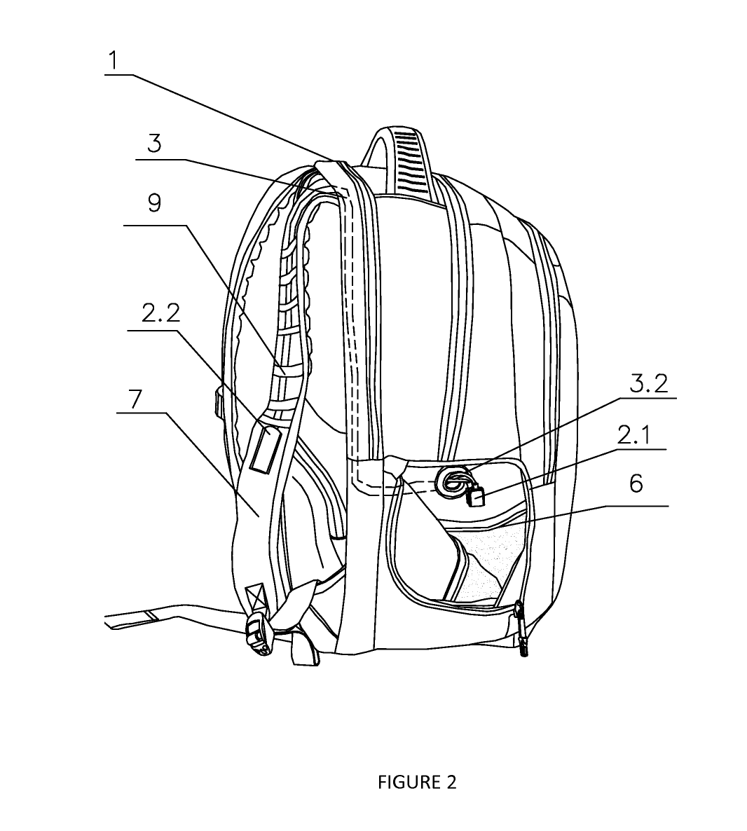

FIG. 2 shows embodiment 2 of the utility model, which is different to the embodiment 1. The said cable laying channel (3) is equipped with first port (3.1) on the surface of said bag or luggage body (1) and second port (3.2) is inside the said bag or luggage body (1). The said male connector (2.1) is arranged outside the first port (3.1) of cable laying channel (3). The said female connector (2.2) is arranged outside the first port (3.1) of cable laying channel (3). At least one piece of velcro (9) is designed and can be opened off the side of first port (3.1) on the said cable laying channel (3). Electrical storage device placing space (6) is inside the bag or luggage body (1).

After the velcro is pulled apart, first port (3.1) of cable laying channel (3) can be opened, which makes it easy to pull out female connector (2.2) from first port (3.1).

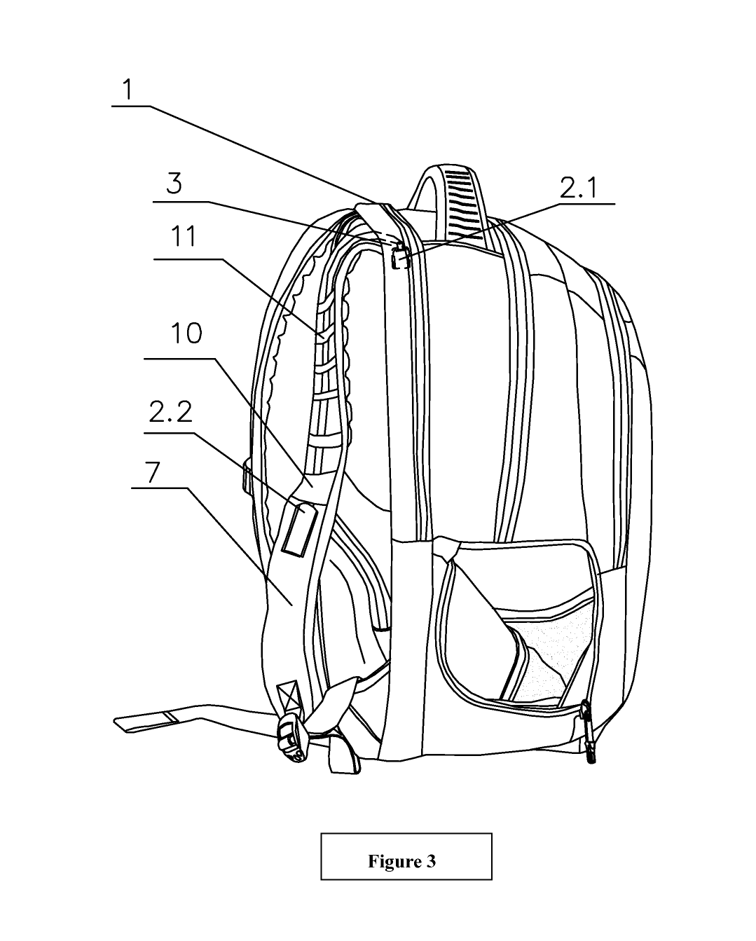

FIG. 3 shows a bag or luggage for convenient charging, comprising bag or luggage body (1), cable laying channel (3), power cable (2), male connector (2.1) and female connector (2.2). The feature is: the said cable laying channel (3) has first port (3.1) on the outer surface of said bag or luggage body (1) and second port (3.2) is inside the said bag or luggage body (1) and the male connector (2.1) is on the outer surface of second port (3.2) on the said power cable (2) and the female connector (2.2) of said power cable (2) is outside first port (3.1). At least one elastic (10) and many ribbons (11) that can be used to open the channel are designed off the side of first port (3.1) on cable laying channel (3). Electrical storage device placing space (6) is inside the bag or luggage body (1).

If the elastic (10) is opened, power cable outlet of female connector (2.2) can be easily drawn out of first port. The said first port (3.1) of the cable laying channel (3) is on a shoulder strap (7) of the bag or luggage body (1). The said second port (3.2) of the cable laying channel is inside the joint point of shoulder strap and the said bag and luggage body (1). The said channel starts from first port (3.1) and stretches from shoulder strap (7) to the joint point of shoulder strap (7) and the bag or luggage body (1). It, in the end, extends toward second port (3.2) along the cable laying channel.

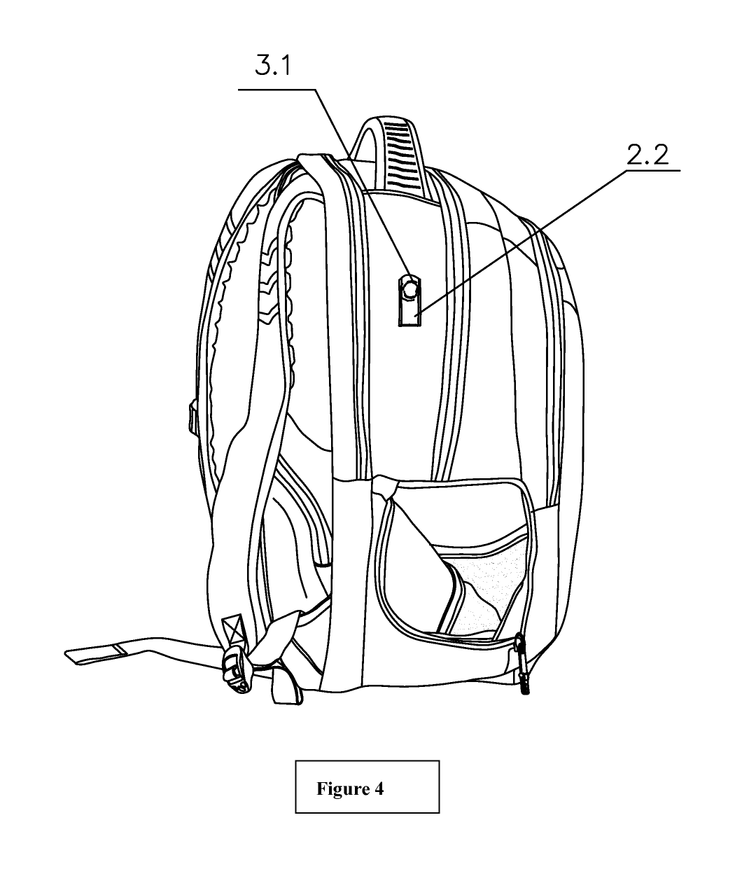

FIG. 4 shows first port (3.1) on cable laying channel (3) can be designed anywhere on the bag or luggage body. For example, it can be designed off the side of the bag or luggage body.

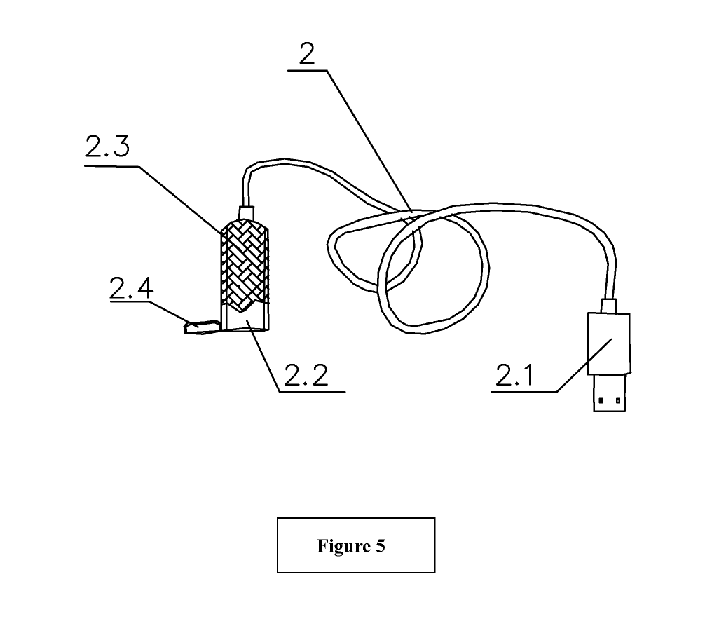

FIG. 5 shows that the said female connector (2.2) is wrapped by water proofing sheath (2.3) outside the female connector (2.2) and the sheath (2.3) is covered by dust cap (2.4).

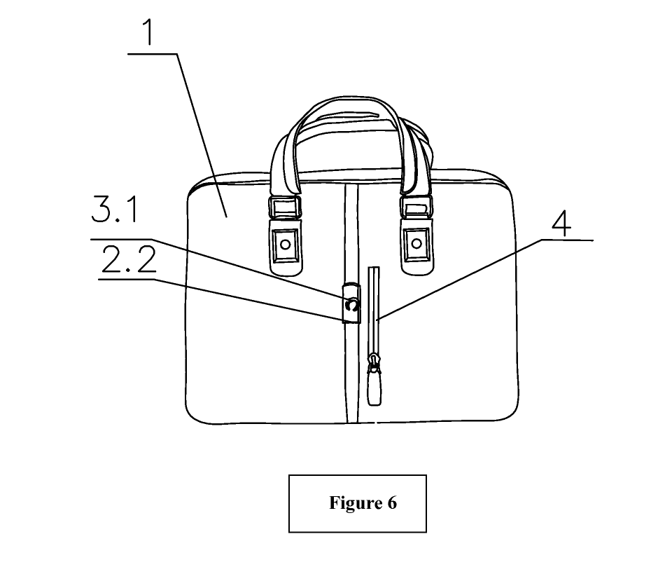

FIG. 6 shows first port (3.1) on the cable laying channel (3) is designed within the groove (5) off any front side of the bags body (1).

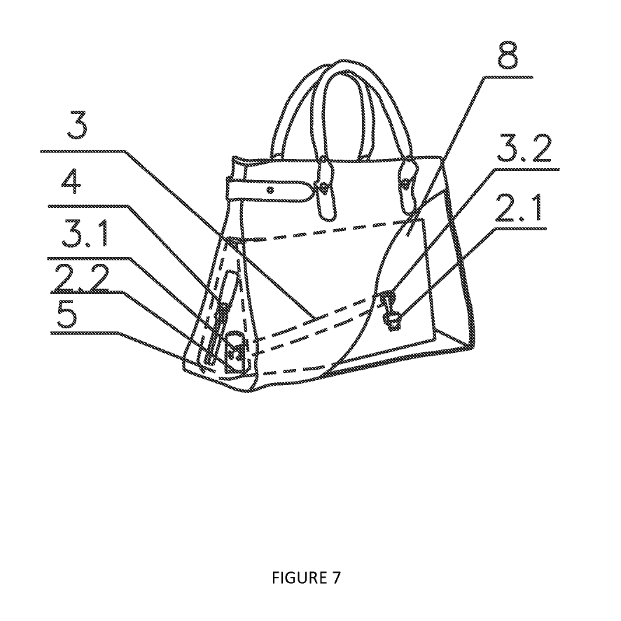

FIG. 7 shows first port (3.1) on the cable laying channel (3) is designed within the groove (5) off any side of the hand bag body (1). The said second port (3.2) on the cable laying channel (3) is designed on the inner layer within the hand bag body (1). The cable laying channel extends from first port (3.1) to the groove (5) and the inner layer (8) within the hand bag body (1). Then it stretches toward the second port (3.2) along the inner layer.

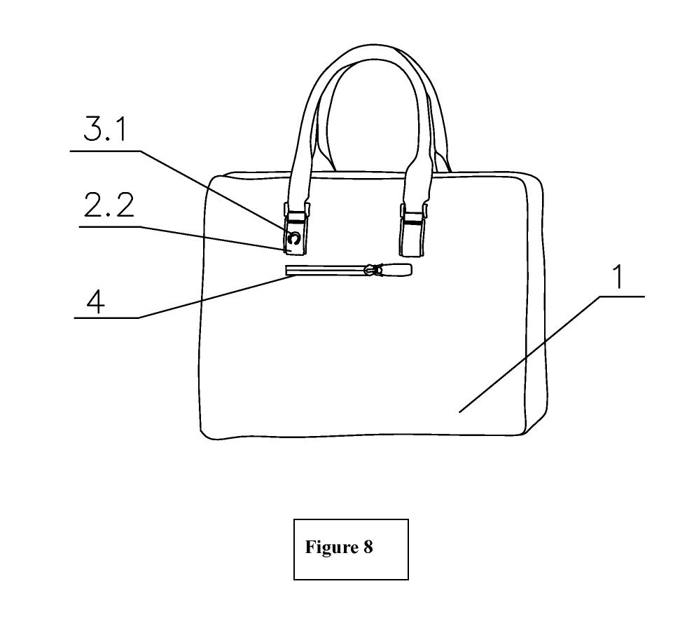

FIG. 8 shows first port (3.1) on the cable laying channel (3) is also can be designed on any position of handle of the bags body (1).

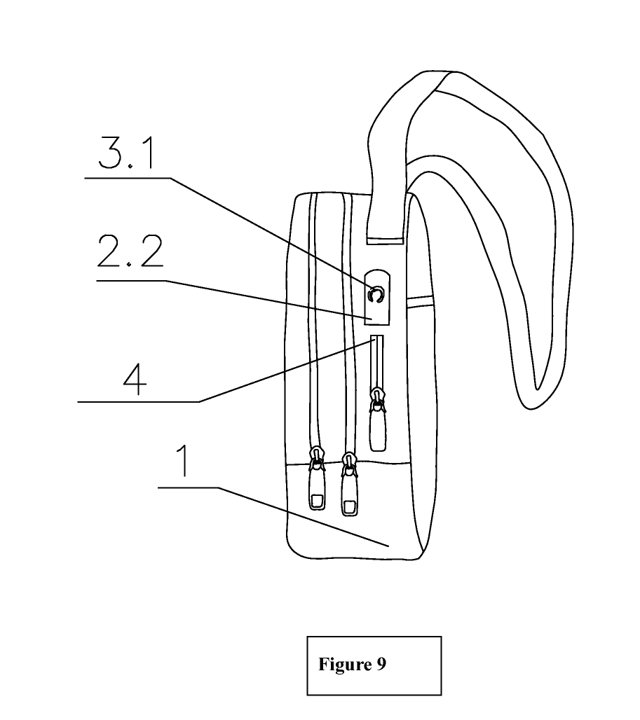

FIG. 9 shows first port (3.1) on the cable laying channel (3) is also can be designed on any side of the shoulder bags body (1).

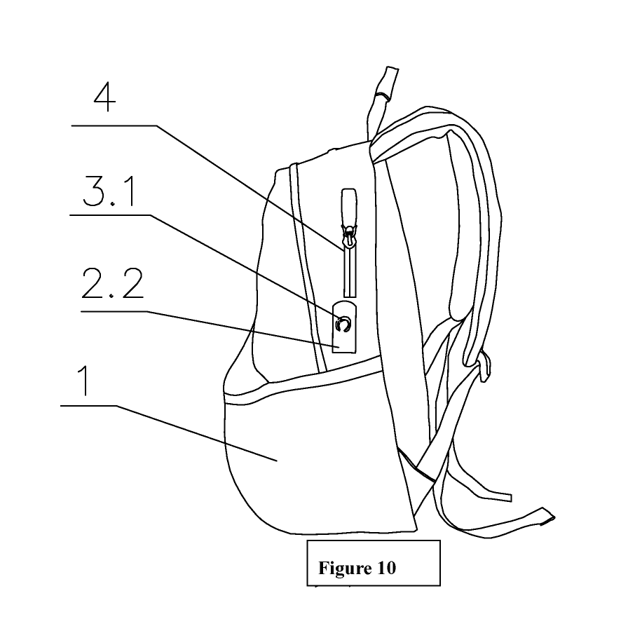

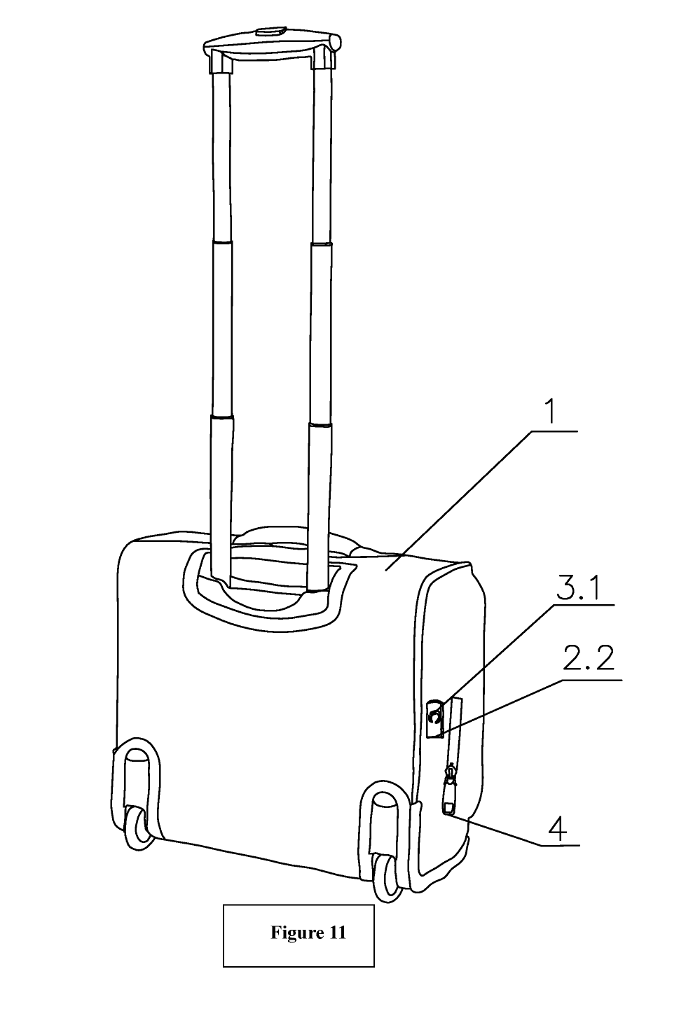

FIG. 10 shows first port (3.1) on the cable laying channel (3) is also can be designed on any side of the backpack body (1).

### Embodiment 11

FIG. 7 shows this embodiment of the utility model, which is a rod box. Off the side of first port (3.1) on the cable laying channel (3), there is a zipper (4) able to connect or separate the channel.

The embodiments of the above are just detailed explanations of the technical scheme of the utility model. The utility model is not only confined to the above examples; any improvement or replacement made based on the utility model should be considered within the protection scope of the utility model.

I claim:

1. A luggage or bag for convenient replacement of a charging cable, comprising:
a bag body having an outer surface, an inside and a battery storage space;
a cable laying channel having a power cable therein;
wherein said power cable has a male connector and female connector,
wherein the cable laying channel has a first port at the outer surface of the bag body and a second port at the inside of the bag body,
wherein the male connector of the power cable is exposed outside the second port of the cable laying channel and the female connector of the power cable is exposed outside the first port of the cable laying channel; and
a channel closing or opening accessory provided at the side of the first port of the cable laying channel.

2. A luggage or bag for convenient replacement of a charging cable according to claim 1, wherein the channel closing or opening accessory is selected from the group consisting of a zipper, buckle, button, magic tape, elastic bad, ribbon and welding.

3. A luggage or bag for convenient replacement of a charging cable according to claim 1, wherein the first port of the cable laying channel is provided on a shoulder strap of the bag body, the second port of the cable laying channel is above the battery storage space and away from a panel of a joint between the shoulder strap and bag body, wherein the cable laying channel extends from the first port to the joint between the shoulder strap and the bag body along the shoulder strap, then extends along the side of bag body to the bottom of the bag body, then extends to the battery storage space away from the panel of the joint between the shoulder strap and the bag body along the bottom of the bag body and extends to the second port above the power storage space along the power storage space.

4. A luggage or bag for convenient replacement of a charging cable according to claim 1, wherein the first port of the cable laying channel is provided on the shoulder strap of the bag body and the second port of the cable laying channel is inside the panel of the joint between the shoulder strap and the bag body, wherein the cable laying channel extends from the first port to the joint between the shoulder strap and the bag body along the shoulder strap and extends to the second port of the cable laying channel.

5. A luggage or bag for convenient replacement of a charging cable according to claim 2, wherein the first port of the cable laying channel is provided on the shoulder strap of the bag body and the second port of the cable laying channel is inside the panel of the joint between the shoulder strap and the bag body, wherein the cable laying channel extends from the first port to the joint between the shoulder strap and the bag body along the shoulder strap and extends to the second port of the cable laying channel.

6. A luggage or bag for convenient replacement of a charging cable according to claim 1, wherein the first port of the cable laying channel is placed anywhere in the bag body.

7. A luggage or bag for convenient replacement of a charging cable according to claim 2, wherein the first port of the cable laying channel is placed anywhere in the bag body.

8. A luggage or bag for convenient replacement of a charging cable according to claim 1, wherein the first port of the cable laying channel is inside a groove of any side of the bag body and the second port of the cable laying channel is inside an inner interlayer of the bag body and the first port of the cable laying channel extends to the inner interlayer of the bag body through the groove and extends to the second port along the inner interlayer.

9. A luggage or bag for convenient replacement of a charging cable according to claim 2, wherein the first port of the cable laying channel is inside a groove of any side of the bag body and the second port of the cable laying channel is inside an inner interlayer of the bag body and the first port of the cable laying channel extends to the inner interlayer of the bag body through the groove and extends to the second port along the inner interlayer.

10. A luggage or bag for convenient replacement of a charging cable according to claim 1, wherein the female connector is equipped with a sheath for waterproofing wrapped on the outer surface of the female connector and the sheath is further equipped with a dust cap for dust proofing.
